(19) United States
(12) Patent Application Publication
(10) Pub. No.: US 2004/0241372 A1
(43) Pub. Date: Dec. 2, 2004

(54) Surface protection film for painted surfaces with an adhesive based on hydrogenated block copolymers

(76) Inventor: Thorsten Krawinkel, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/487,467

(22) PCT Filed: Jul. 30, 2002
(86) PCT No.: PCT/EP02/08437

(30) Foreign Application Priority Data
Aug. 23, 2001 (DE) 101 41 378.5

(51) Int. Cl. B32B 27/00

(52) U.S. Cl. 428/41.7; 428/500; 428/40.1

(57) ABSTRACT

Self-adhesive protective film for painted surfaces comprising a single- or multi-layered, in particular polyolefinic support layer and a self-adhesive layer, characterised in that the self-adhesive layer is made up as follows: 30 to 70 wt. % of one or several elastomers based on block copolymers, comprising polymer blocks formed from vinyl aromatics (A blocks), preferably styrol and those formed by polymerisation of 1,3-dienes (B blocks), preferably butadiene and isoprene, or the hydrogenation products thereof and 30 to 70 wt. % of adhesive resins, whereby at least half of the adhesive resins are liquid adhesive resins with a softening point of below 25° C. as measured by the ring and ball method.

The invention relates to a self-adhesive protection film for protecting surfaces such as glass, ceramic, stainless steel, polycarbonate glass or acrylic glass, especially painted surfaces.

For surface protection on unpainted areas there are a multiplicity of products. Conversely, painted areas, particularly in their fresh, uncured state, have only rarely to date been covered with self-adhesive protection films.

The preservation and protection of motor vehicles in transit from manufacturer to dealer has long been common practice.

The conventional method of preserving automobiles involves applying paraffin waxes in a thickness of from 5 to 20 μm. However, it has been found that, especially on horizontal areas of the vehicles, such as hood, roof, and trunk lid, such a thin and usually nonuniform coat does not afford adequate protection against external influences, such as acid rain and the corrosive effect of bird droppings, for example.

A considerable drawback of sealing with paraffin wax, moreover, is the need to remove the preservative using a steam jet, surfactants or solvents. Environmentally sound recovery and disposal of residues entail considerable deployment of apparatus and also very high costs.

One current development in the field of automobile transit protection is the use of covers which go over the entire vehicle and are shrunk on to fit by exposure to heat.

Cover solutions of this kind are very costly and involve a great deal of effort in applying the cover, effecting shrinkage, and especially for entry to the masked vehicle. For that particular purpose, zipper openings are provided, whose necessary opening and reclosing is time-consuming. Visibility when maneuvering is severely impaired, and enclosed dirt and unavoidable scuffing result in dulling on the paint in certain areas. This solution has not so far become established.

In recent years, instead, increased use has been made of self-adhesive surface protection films which are applied temporarily. They are specifically intended for the transit protection of fresh motor vehicles, have a much better protective effect than the waxes against mechanical and chemical influences, and have the advantage over the covers of being more favorably priced and much quicker to apply.

Key requirements imposed on a surface protection film for motor vehicle finishes are

Good protective effect for the paint against chemical and mechanical influences.

Weathering stability over the entire period of the transport chain from plant to dealer, which depending on distance may amount to several months. Thus a film of this kind must be removable in one piece even after long; intense sunlight exposure and must not leave any residues of adhesive on the paint.

Sufficient initial tack, so as not to detach prematurely of itself in difficult bonding geometries.

Balanced final bond strength, so that the film on the one hand adheres securely (even with a strong slipstream or in rain) but on the other hand can be removed without great force or even tearing. Ideally, the desired bond strength will be present from the start. In practice, however, the adhesion is weaker to start with and then increases over time, and particularly under the ‘effect of’ temperature. This is referred to in the language of the art as “peel increase”.

Paint compatibility, which means that following removal of the protection film the paint surface must not exhibit any deterioration whatsoever in the form of deposits or deformations. Deformations are impressions in the paint which are manifested on the one hand as contours of film edge, air bubbles included in the bond, and creases, and on the other hand as dulling under the entire overstuck area.

High UV stability, so that the adhesive is not broken down under weathering and either loses its bond strength or reacts with the paint surface.

In the case of painted surfaces not subject to weathering, such as painted furniture, there is less need to place import on the excellent UV stability of the protection film.

In accordance with the prior art, film materials used to cover vehicle finishes are generally polyolefins or mixtures thereof, which are commonly blended with light stabilizers and titanium dioxide.

A diversity of systems are used as self-adhesive compositions, but without exception are hampered by weaknesses.

Self-adhesive compositions based on natural rubber possess relatively good initial adhesion and can be removed again without residue. On even short-term exposure to UV radiation, however, these compositions are not stable to aging. Following realistic weathering exposures over a period of several months, this leads to severe greasy residues or hardened paintlike residues on the finish.

U.S. Pat. No. 5,612,136 A1 mentions a protection film having an acrylate-based self-adhesive composition. Polyacrylate compositions are indeed highly UV stable. If, however, uncrosslinked polyacrylate compositions are stored under alternating climatic conditions, their compatibility with paint surfaces is good only in some cases. Moreover, the polyacrylate compositions exhibit an undesirable extent of peel increase, i.e., the removal of the film after some time requires great force. Where these compositions are strongly crosslinked chemically or by radiation, they are indeed easier to remove, but on the other hand cause increased incidence of clearly visible, permanent deformations of the paint surface.

The adhesive film described in DE 195 32 220 A1, with polyethylene-vinyl acetate adhesive (EVAc), possesses much better adhesion properties than the two systems described above. Protection films featuring EVAc compositions achieve good bond values after just a short time and ensure great bonding security against unwanted self-induced detachment during transit. On the other hand, the bond strength becomes a disadvantage in the case of removal after use, since, as in the case of the polyacrylate compositions, the expenditure of force is much too high, and so the adhesive film frequently cannot be removed without tearing. The effect on the paints to be protected is generally low. The UV stability is deserving of particular emphasis.

Although self-adhesive compositions based on polyisobutylene (polyisobutylene homopolymer or butyl rubber) can be removed again with significantly greater ease after storage, their adhesion to finishes customary in the automobile industry following storage under alternating climatic conditions is in some cases so low that under jerky stresses, such as on flapping in the slipstream, they do not always sufficiently attain the bond strength required in practice. Under the influence of moisture, in particular, the adhesion is frequently reduced to such an extent that the film detaches from the protected vehicles in transit, resulting firstly in a loss of protection and secondly in a safety risk if the film drifts onto the windshield of following vehicles.

Furthermore, this self-adhesive composition is incompatible with the sealing profiles that are customary in automobile construction, or with the plasticizers they contain: when the protection film is removed from window profiles, residues of the adhesive remain on the rubber. Adhesive articles of this kind are described in EP 0 519 278 A1, JP 95-325285 A and U.S. Pat. No. 5,601,917 A1.

EP 0 519 278 A1 describes such a film for protecting automobiles that is composed of a backing coated with a pressure-sensitive adhesive based on rubber, especially polyisobutylene, which has a dynamic elasticity modulus of from 2×10⁵ to 7×10⁶ dyn/cm², corresponding in SI units to a figure of from 2×10⁴ to 70×10⁴ Pa, at 60° C.

Performance tests with a self-adhesive film of this kind show good compatibility with paint surfaces. The adhesion following storage under alternating climatic conditions on finishes customary in the automobile industry, however, is so low that the bond strength required in practice is not always adequately present.

Likewise a disadvantage is the aging behavior of the polyisobutylenes. Polyisobutylenes are susceptible to aging by UV radiation, which significantly lowers the cohesion. This leads to residues on the paint after demasking. For this reason the polyisobutylene-based adhesive film on the market is highly pigmented: the decomposing effect of light is to be kept as far as possible away from the adhesive. In the edge region, however, the adhesive is subjected directly to UV light, leading there to significant residues. An attempt to avoid this is made by adding antioxidants and HALS light stabilizers to the polyisobutylene: these additives are described in U.S. Pat. No. 5,601,917 A1.

The adhesive DE 197 42 805 A1 describes is based on a copolymer composed of at least two different olefins having 2 to 12 carbon atoms and a diene. Preference is given to using ethylene-propylene-diene terpolymers (EPDM). Apolar ethylene-propylene-diene polymers feature good weathering stability and UV stability, and so are outstandingly suitable as an adhesive for surface protection films. The terpolymers the patent describes possess a Mooney viscosity ML (1+4) at 125° C. of less than 50.

Investigations on various EPDM specimens have shown that the adhesion capacity of EPDM polymers decreases as their Mooney viscosity goes up: only grades with a Mooney viscosity ML (1+4) at 125° C. of less than 30 have a sufficient inherent tack. For application as a temporary self-adhesive composition, however, the cohesion of these EPDM grades is too low (in analogy to WO 96/37568 A1), leading to residues of adhesive on the paint surface after weathering.

Example 1 in DE 197 42 805 A1 describes a self-adhesive protection film comprising an adhesive composed of an EPDM having a Mooney viscosity ML (1+4) at 125° C. of 28 along with a light stabilizer. In the case of this protection film a sufficient high bond strength on a PU paint surface, of 0.4 N/cm, is obtained.

A considerable disadvantage, however, owing to the low molecular weight of the polymer, is that following storage at elevated temperature (90° C.) it is not possible to remove this protection film without residue from the paint surface. Even at slightly increased removal temperatures of 40° C. this adhesive fails completely and is transferred to the paint surface over the entire area. When removal is carried out at a realistic speed of 20 m/min a sharp increase in the removal forces (4.3 N/cm) and full-area residues of adhesive on the paint surface are observed. When the protection film is removed from test paint surfaces at a lower speed of 0.3 m/min (in accordance with AFERA 4001 or DIN EN 1939), conversely, following storage under alternating climatic conditions, only local residues of adhesive are observed, and bond strengths of 2.3 N/cm are measured.

In practice, however, the vehicles are demasked with a higher removal speed of at least 15 to 30 m/min, so that the measurement of the bond strengths in accordance with AFERA 4001 and/or DIN EN 1939 is not actually relevant. Assessing the suitability of a self-adhesive protection film on the basis of these measurement methods is not an option.

Attempts are made in Examples 2 and 4 of the description to counter the strong peel increase by crosslinking the adhesive by means of electron beams and, respectively, UV radiation. In this case a bond strength on paint (removal speed 0.3 m/min) following storage under alternating climatic conditions of 2.2 N/cm is obtained. The corresponding figure following storage under alternating climatic conditions with a removal speed of 20 m/min is 3.4 N/cm. Crosslinking raises the cohesion of the adhesive, allowing residues of adhesive on the paint surface following removal therefrom to be avoided. The greater cohesion of the adhesive is likewise reflected in the absence of residue when the protection film is removed from painted metal test panels at temperatures up to 60° C. Owing to the crosslinking, however, the adhesive is now relatively hard, leading to considerable deformations of the paint surface and also to an inadequate initial bond strength of 0.2 N/cm.

A further example is a poly-α-olefin-based adhesive (DE 197 30 193 A1). With this surface protection film there is likewise a considerable discrepancy observed between the bond strengths at low and at high removal speeds. In analogy to DE 197 42 805 A1 the examples here too use only polymers having a Mooney viscosity ML (1+4) at 125° C. of less than 50. Likewise, therefore, as a result of the low cohesion, severe peel increase and residues of adhesive on the paint surface are observed. The removal forces are above 3.2 N/cm.

WO 96/37568 A1 describes the use of polyhexene and/or polyoctene for an apolar pressure-sensitive adhesive. Although, owing to- the low cohesion, the polymers. described in the examples exhibit low peel increase, the low molecular weight of such commercially customary polymers means that they too lead to residues, a phenomenon which it is attempted to avoid by adding other polymers, called “cold flow restricting agents” therein. Nevertheless, the adhesives specified still lack adequate cohesion for practical purposes, leading after weathering to residues, especially if the adhesive tape shrinks through heat exposure.

Substantially more UV-stable than polyisobutylenes are adhesives comprising hydrogenated styrene-diene block copolymers, as described in JP 08 027 444 A1. An advantage is the high cohesion of these adhesives, especially at moderate temperatures, as a result of the formation of domains.

A substantial disadvantage of such block copolymers is the hardness of these adhesives, which is so high as a result of the styrene domains. Owing to the high level of hardness the use of this kind of adhesive is accompanied by severe deformations and changes in the paint, especially following prolonged storage.

The only polymers suitable as an apolar adhesive base for surface protection featuring sufficiently high cohesion are polymers from the classes of the polyisobutylenes and butyl rubbers, the hydrogenated styrene block copolymers, and the ethylene/propylene copolymers, including terpolymers.

It is an object of the following invention to utilize the advantages of the adhesive system based on styrene block copolymers, namely good initial adhesion, high bonding security, and low peel increase, and to find a way to reduce significantly the substantial drawback of the severe paint deformations without adversely affecting the strengths, in order therefrom to provide a surface protection film particularly for the transit protection of automobiles straight out of the plant gates.

This object is achieved by means of a self-adhesive protection film as specified in the main claim. The dependent claims relate to advantageous developments of the self-adhesive protection film and also to particular possibilities for its application.

Surprisingly and unexpectedly even for the skilled worker a self-adhesive protection film having a single-ply or multi-ply backing layer, especially a polyolefinic backing layer, and a self-adhesive layer exhibits the properties this requires for surface protection applications on painted surfaces.

The self-adhesive composition of the protection film is constructed as follows:

| | |
|---|---|
| 30 to 70% by weight | of one or more elastomers based on block |
| | copolymers, and also |
| 30 to 70% by weight | of tackifier resins, at least half of the tackifier |
| | resins being liquid tackifier resins having a |
| | softening point of below 25° C. as measured |
| | using the ring and ball method. |

Elastomers employed include those based on block copolymers including polymer blocks formed by vinylaromatics (A blocks), preferably styrene, and blocks formed by polymerizing 1,3-dienes (B blocks), preferably butadiene and isoprene, or, with particular preference for UV-stable adhesives, their hydrogenation products. Both homopolymer and copolymer blocks can be utilized in accordance with the invention. Resultant block copolymers may contain identical or different B blocks. Block copolymers can have a linear A-B-A structure; likewise possible for use are block copolymers of radial design and also star-shaped and linear multiblock copolymers. Further components present may include A-B diblock copolymers. Block copolymers of vinylaromatics and isobutylene are likewise possible for use in accordance with the invention. All of the aforementioned polymers may be utilized alone or in a mixture with one another.

Instead of the polystyrene blocks it is also possible to utilize polymer blocks based on other aromatics-containing homopolymers and copolymers (preferably C-8 to C-12 aromatics) having glass transition temperatures of > approximately 75° C., such as α-methylstyrene-containing aromatics blocks, for example.

Instead of styrene-butadiene block copolymers and styrene-isoprene block copolymers and their hydrogenation products, including styrene-ethylene/butylene block copolymers and styrene-ethylene/propylene block copolymers, it is likewise possible in accordance with the invention to utilize block copolymers and their hydrogenation products which utilize other polydiene-containing elastomer blocks, such as, for example, copolymers of two or more different 1,3-dienes. Further suitable for use in accordance with the invention are functionalized block copolymers, such as maleic anhydride-modified or silane-modified styrene block copolymers, for example.

In accordance with one outstanding embodiment of the invention the elastomers are hydrogenated predominantly in the middle block, and in particular are hydrogenated completely in the middle block.

As further additives it is possible typically to use the following:

primary antioxidants, such as sterically hindered phenols, for example

secondary antioxidants, such as phosphites or thioethers, for example

in-process stabilizers, such as C-radical scavengers, for example

light stabilizers, such as UV absorbers or sterically hindered amines, for example

processing assistants and also

if desired, further polymers, preferably elastomeric in nature. Elastomers which can be utilized accordingly include those based on pure hydrocarbons, examples being saturated ethylene-propylene copolymers, and ethylene-propylene rubber.

The adhesives of the invention based on hydrogenated styrene block copolymers are substantially softer than the known adhesives but nevertheless still possess adequate cohesion.

Since the styrene block copolymers are not by nature pressure-sensitively adhesive they must be made so by the addition of tackifier resins.

Owing to the UV stability required for automotive finishes in particular, pressure-sensitive adhesives of this kind normally utilize hydrogenated tackifier resins as the main component of their tackifiers.

Those with preferred suitability include the following:

hydrogenated polymers of dicyclopentadiene (for example, Escorez 5300 series; Exxon Chemicals),

hydrogenated polymers of preferably C-8 and C-9 aromatics (for example, Regalite and Regalrez series; Hercules Inc.//Arkon P series; Arakawa); these can be formed by hydrogenating polymers comprising pure aromatics streams or by hydrogenating polymers based on mixtures of different aromatics,

partially hydrogenated polymers of C-8 and C-9 aromatics (for example, Regalite and Regalrez series; Hercules Inc.//Arkon M; Arakawa),

hydrogenated polyterpene resins (for example, Clearon M; Yasuhara),

hydrogenated C-5/C9 polymers (for example, ECR-373; Exxon Chemicals),

aromatics-modified selectively hydrogenated dicyclopentadiene derivatives (for example, Escorez 5600 series; Exxon Chemicals), and

fully and partly hydrogenated rosin-based resins (for example, Foral, Foralyn; Hercules//Hydrogral; DRT).

For utility as surface protection film subject to UV exposure, hydrogenated hydrocarbon resins are principally employed.

In the case of applications where resistance to UV light is not so critical it is also possible to use nonhydrogenated tackifier resins, alone or as blend components of the hydrogenated tackifier resins.

In order to reduce the bond strength of the adhesives for subsequent demasking in the case of reversible adhesive tapes it is common to use adhesives having a very high (more than 60%) elastomer fraction. The higher the elastomer fraction, however, the harder the adhesive. But a hard adhesive generally results in very severe paint deformations, which is why the adhesives should be given a softer formulation. Plasticizers in the conventional sense, such as mineral oils, for example, do not lead only to lower hardness of the adhesives but also reduce their cohesion, with the consequence that demasking is frequently possible only with difficulty, on account of the adhesive residues which remain. On painted surfaces in particular the use of plasticizing oils is critical, since they can migrate into the paint and so lead to deformations.

In accordance with the invention the problem is solved, surprisingly, through the use of liquid resins.

Liquid resins are routinely used as a blend component with solid resins in order to lower the glass transition temperature. Adhesives of the invention are based on styrene block copolymers which as resin component primarily or exclusively use liquid resins.

As a result it is possible to make the adhesives very much softer than conventional adhesives based on styrene block copolymers, but with the high cohesion retained. In contrast to plasticizing oils, liquid resins have much less of a tendency to migrate into the paint.

Since the bond strengths are much lower than in the case of solid resins, blends of styrene block copolymers only with liquid resins as tackifier resin component are generally not employed. In the specific case of surface protection films, however, a low bond strength is of advantage.

Suitable liquid resins include both hydrogenated (for example, Regalrez 1018, Hercules//Escorez 5040, ECR 143, Exxon) and nonhydrogenated hydrocarbon resins (for example, Wingtack 10, Goodyear//Hercures A 10, Hercures C 10, Hercules) and hydrogenated (for example, Staybelite Ester 3E, Hercules//Hydrogral M, DRT) or nonhydrogenated derivatives of rosin (for example Abalyn, Hercolyn D, Hercules//Bevipale 30, Arizona). However, use should not be made of resins which owe their low softening point merely to the fact that they have been blended with oil, as is the case with the majority of liquid terpene resins.

Liquid resins for the purposes of the invention are tackifier resins which have a softening point of below 25° C. as measured by the ring and ball method.

The ring and ball method is the standard method of ascertaining softening points. Details can be found in ASTM E 28 and DIN EN 1238, which are hereby expressly incorporated by reference.

Adhesives of the invention contain from 50 to 200 parts of resin, based on the elastomer. The resin fraction is composed in turn of at least 50% of liquid resins, preferably more than 75%, more preferably more than 90%, and very preferably 100%.

With further preference the liquid tackifier resins are hydrogenated hydrocarbon resins.

It has thus then proven particularly advantageous if no plasticizing oil is employed.

A particular advantage of the systems comprising styrene block copolymer(s) and liquid resin(s) is the very low peel increase on the substrate. There is very little difference between the bond strengths after half an hour and after storage at 90° C. for 3 days. Thus, in the case of use on motor vehicle finishes, transit can be commenced a very short time after application without any risk of the protection film being detached by the slipstream. And, further, the bond strength has not substantially increased after long storage, allowing easy demasking.

Another advantage over other systems is the possibility of setting the bond strengths very exactly. The variation and combination of elastomers and also use of liquid resins as an individual component or as a mixture and the possibility of introducing more solid tackifier resins in a low concentration makes it possible to tailor the bond strength precisely to the requirements.

Even when using only one elastomer and one liquid resin it is possible to vary the bond strengths greatly via the proportion of the two. Care must be taken in this case not to use too great a resin fraction, since the cohesion suffers from this.

By using nonhydrogenated elastomers, alone or in a mixture with hydrogenated elastomers, it is possible to obtain very high bond strengths; albeit only for service where the UV stability of the adhesive is of minor importance.

The cohesion of the adhesives is so high that even after storage at high temperatures (90° C., see Examples below) no residues of adhesive are evident on the paint after demasking.

Following storage under alternating climatic conditions the protection film can be removed without residue from painted surfaces at speeds of 20 m/min with a bond strength of from 2.3 to 3.6 N/cm. Additionally, detachment of the protection film without residue after storage under alternating climatic conditions is possible up to a temperature of at least 50° C.

The bond strength on steel is preferably 0.1 and 2 N/cm, in particular between 0.3 and 1 N/cm.

The self-adhesive compositions described can be applied either from solution to a backing film or by coextrusion simultaneously with the backing layer and further, auxiliary layers.

Used preferably for the backing layer of the adhesive is a thermoplastic polyolefin film which is unoriented and includes at least one polyolefin from the group of polyethylenes (for example, HDPE, LDPE, MDPE, LLDPE, VLLDPE, and copolymers of ethylene with polar comonomers) and the group of polypropylenes (for example, polypropylene homopolymers, random polypropylene copolymers or polypropylene block copolymers).

Preference is given to using mixtures of different suitable polyolefins in order to allow optimum setting of the mechanical and thermal properties and also gloss, extrusion characteristics, anchoring of the adhesive, and so on.

A particular suitable backing layer is a thermoplastic polyolefin film which is unoriented and includes at least one polypropylene block copolymer. The amount of-polypropylene block copolymer makes up from 10 to 95% (w/w) of the protection film.

Films of this kind can be produced on film blowing lines or, preferably, casting lines (T-die technology), with the film not being monoaxially or biaxially oriented by drawing (stretching) with stretching rolls or stretching frames. The orientation is to be minimized when blowing such a film, by way of the take-off speed, blow-up ratio, and temperature profile.

The polypropylene block copolymers used (also called impact resistant polypropylene) are described in the literature in Encycl. Polym. Sci. Technol. 13, 479ff (1988) and in Ullmann's Encyclopedia of Industrial Chemistry A21, 529ff (1992). Examples of trade names are Propathene GSF 113 (ICI), 411 GA 05 (Amoco), PMA 6100 (Montell), Stamylan P (DSM), BD 801 F (Borealis), Daplen FFC1012 (PC) and Novolen 2309 L.

Block copolymers of this kind differ substantially from one another in terms of their melt index (=MFI=MFR) and their comonomer content. The melt index influences the strength of the film and the fluidity of the melt in opposite ways. Advantageous for the production of the protection film of the invention is a melt index of from 0.8 to 15 g/10 min (ISO 1133 (A/4) at 230° C. and 2.16 kg), in order to achieve the requirements for toughness and tensile strength on the one hand and for processibility (production speed and uniformity of thickness in the case of coextruded films) on the other. The preferred range lies between 4 and 10 g/10 min. With this product, coextrusion is a suitable means of introducing the adhesion promoter layer during the production of the film.

Where backing film and adhesive are joined to one another by coextrusion, great importance attaches to the selection of the melt index of the polypropylene block copolymer and of the other thermoplastic constituents of the film formula. The comonomer content of the polypropylene block copolymer determines the softness, tensile impact strength, and heat stability of the protection film produced from them. The protection film of the invention preferably includes a polypropylene block copolymer containing from 3 to 15% (w/w) of ethylene as comonomer. The tensile impact strength according to DIN 53448 should amount to at least 1000 mJ/mm² both longitudinally and transversely.

Further constituents used may include, for example, polyethylene (such as HDPE, LDPE, MDPE, LLDPE, VLLDPE), copolymers of ethylene or propylene with polar comonomers, polypropylene homopolymers or random polypropylene copolymers for fine-tuning the properties (mechanical, thermal or other properties such as gloss, adhesion of the adhesive, extrusion characteristics, etc.). Particularly advantageous is the combination of two or more polypropylenes, differing in particular in softness and melt index, such as, for example, soft block copolymer with PP homopolymer or a hard block copolymer grade, since toughness, heat stability, and rheology can be adapted more effectively to the requirements than when using just a block copolymer. For sufficient heat stability the fraction of propylene in a film layer should be at least 65% (w/w). When the film layer is of multi-ply construction, it is this layer which is responsible for the strength and which therefore includes the highest polypropylene fraction (and generally also has the greatest thickness), and not any adhesion promoter layer.

With further preference the film may be composed of a mixture of

40 parts to 70 parts by weight of polyethylene,

20 parts to 40 parts by weight of polypropylene,

8 parts to 15 parts by weight of titanium dioxide,

0.3 part to 0.7 part by weight of light stabilizers.

Of the 40 to 70 parts by weight of polyethylene in the film it is preferable for 30 to 50 parts by weight to be composed of high-impact polyethylene.

For the backing films a thickness of from 20 to 80 μm is preferred, including where appropriate an adhesion promoter layer, disposed between the backing layer and the adhesive layer.

The softness of the backing film plays a part in connection with the deformability of the protection film during application: the force at 10% elongation should not exceed 25 N/15 mm, preferably 16 N/15 mm, in either the longitudinal or transverse directions (tensile test in accordance with DIN EN ISO 527-7-5). Therefore the backing films ought to be unoriented. Stretching raises the force at 10% elongation so greatly that conformability is no longer a given.

In order to give the backing film the weathering stability that may be required it is preferred to add light stabilizers. Their function consists primarily in preventing embrittlement of the backing film. Light stabilizers of this kind are described in Gaechter und Müller, Taschenbuch der Kunststoff-Additive, Munich 1979, in Kirk-Othmer (3rd) 23, 615-627, in Encycl. Polym. Sci. Technol. 14, 125-148, and in Ullmann (4th) 8, 21; 15, 529, 676. HALS light stabilizers in particular are suitable for the protection film of the invention. The amount of light stabilizer should be at least 0.15% by weight, preferably at least 0.30% by weight, based on the backing film.

The use of antioxidants for the film (for example, Irganox 1010 or trisnonylphenyl phosphite), though advantageous, is not mandatory. Further suitable UV absorbers, light stabilizers, and aging inhibitors are set out in EP 0 763 584 A1.

Additional improvement in the light stability of the backing film is also possible through the addition of titanium dioxide. Advantageous with regard to the mechanical properties and homogeneity of the whiteness is the addition of titanium dioxide at from 5 to 15% by weight.

As a result of the interplay of light stabilizers and pigments the UV transmittance of the protection film in the range from 290 to 360 nm is preferably below about 1%, more preferably below about 0.1%.

The protection films produced in this way feature good adhesion to a variety of the paints customary in the automobile industry, and so even under the effect of wind or under tension as a result of bonding to curved surfaces the protection film does not undergo detachment from the vehicle. Furthermore, the self-adhesive composition exhibits sufficient bond strength particularly within the first few minutes after application, so that after just half an hour, for example, the protection film can be subjected to a severe slipstream load (up to 160 km/h).

The protection film of the invention is therefore particularly suitable for protecting the fresh finish of automobiles during assembly or transit, or as processing and transit protection for freshly painted surfaces. The protection film can be bonded just half an hour after the painted surfaces have passed through the oven, without any disadvantages whatsoever, despite the fact that at this time the paint has not yet fully cured.

A further feature of the protection film of the invention is that it can be applied in great width over the hood, roof, and trunk of automobiles and that, owing to its deformability, it conforms very well to planar and even gently curved shaped areas. It is therefore possible to protect the horizontal areas which are most at risk from soiling. However, even narrow areas such as, for example, the projection of the door below the windows, the entry area, or fenders can easily be covered. Protection of the vertical areas on the vehicle is particularly appropriate during its assembly.

The protection film is resistant to sunlight, heat, and cold, with weathering stability of at least six months. Even very high sun levels, such as are encountered in Florida, for example, do not cause the protection film to fail or detach. The extremely low UV transmittance of the protection film supports the resistance of the adhesive to sun exposure.

Moreover, the strength of the protection film in comparison to preservation with wax ensures impeccable protection against soiling such as bird droppings and against damage to the vehicle as a whole by minor mechanical events. The protection film can be recycled or used for energy recovery, particularly since it is halogen-free.

In particular, the protection films of the invention, by virtue of their high level of adhesion and yet ease of removability after prolonged storage, are suitable for protecting the fresh finish of vehicles such as automobiles and for protecting freshly painted vehicle parts against soiling and damage during assembly, transit, and storage.

Besides the suitability of the films of the invention, as already mentioned, as surface protection films on vehicles, they can also be used outstandingly for protecting surfaces such as glass, ceramic, stainless steel, polycarbonate glass or acrylic glass, and in particular for protecting painted surfaces.

The purpose of the examples below is to illustrate the invention, but without wishing to restrict it unnecessarily.

### EXAMPLES

All of the example films were produced by coating a corona-pretreated polyolefin backing with the toluene solutions of the individual adhesive formulas. The backing was 60 μm thick with the following composition:

60 parts polypropylene block copolymer Daplen FFC 2012 (PCD)

25 parts polypropylene homopolymer Daplen KFC 201 (PCD)

6.3 parts LDPE Lupolen 1840 H (Elenac)

8.4 parts titanium dioxide

0.3 part UV light stabilizer Tinuvin 770 (Ciba-Geigy)

The thickness of the applied layer of pressure-sensitive adhesive following drying was 15 μm in each case, so giving the specimens an overall thickness of 85 μm.

Table 1 above lists example formulas in accordance with the patent claims, and counterexamples.

The specimens were adhered in strips to metal specimen panels with a 1 K [1-component] PU coating (Duraclear II, BASF). The specimens were assessed in accordance with the following criteria:

1. Peel force from paint after 30 minutes at room temperature

2. Peel force from paint after storage at 90° C. for three days

3. Performance assessment of the changes to the paint

Determination of Assessment Criteria

Peel Force From Paint after 30 Minutes at Room Temperature and Peel Force from Paint After Storage at 90° C. for Three Days

The bond strengths were determined at a peel angle of 180° in accordance with AFERA 4001. This was done using steel plates and also metal test panels coated with the PU material as test substrate. In a modified bond strength test the 15 mm wide test strips were removed from a PU-coated metal panel at a speed of 20 m/min and an angle of 180°, with a temperature of 23° C.±1° C. and a relative humidity of 50%±5%.

Performance Judgment on the Changes to the Motor Vehicle Finish

The performance judgment on the changes to the motor vehicle finish expresses a recommendation as to whether the film satisfies the performance requirements of effective paint compatibility.

Table 1: Peel forces from paint after different storage conditions.

Specimen formulas in parts by weight

Peel forces from paint in N/cm

TABLE 1
Peel forces from paint after different storage conditions.
Specimen formulas in parts by weight
Peel forces from paint in N/cm

| Comp. | Example number | 1 | 2 | 3 | 4 | 5 | 6 | 7 | 8 |
|---|---|---|---|---|---|---|---|---|---|
| | Kraton G 1657¹⁾ | 100 | 100 | 100 | 50 | 100 | 100 | 100 | 100 |
| | Kraton D 1102²⁾ | | | | 50 | | | | |
| | Regalite R 1100³⁾ | | | | | | 30 | 100 | 100 |
| | Regalrez 1018⁴⁾ | 100 | 150 | | 100 | 50 | 70 | | |
| | Wingtak 10⁵⁾ | | | 100 | | 50 | | | |
| | Ondina G 41⁶⁾ | | | | | | | | 20 |
| | Irganox 1010⁷⁾ | 0.5 | 0.5 | 0.5 | 0.5 | 0.5 | 0.5 | 0.5 | 0.5 |
| | Peel strength fresh⁸⁾ | 2.0 | 2.4 | 1.7 | 2.4 | 2.1 | 2.6 | 1.8 | 1.4 |
| | Peel strength final⁹⁾ | 2.4 | 2.7 | 2.3 | 3.1 | 2.4 | 3.2 | 2.7 | 2.0 |
| | Performance assessment | sat. | sat. | sat. | sat. | sat. | sat. | unsat. | unsat. |
| | of paint changes | | | | | | | | |

Key: sat. = satisfactory, unsat. = unsatisfactory
¹⁾SEBS with 13% block polystyrene content from Kraton Polymers
²⁾SBS with 30% block polystyrene content from Kraton Polymers
³⁾Hydrogenated HC resin with a softening point of 99° C. from Hercules
⁴⁾Liquid hydrogenated HC resin from Hercules
⁵⁾Liquid nonhydrogenated hydrocarbon resin from Goodyear
⁶⁾Aliphatic-rich plasticizer oil from Shell
⁷⁾Aging inhibitor from Ciba-Geigy
⁸⁾Peel strength from paint after bond time of 30 minutes at room temperature
⁹⁾Peel strength from paint after bond time of 3 days at 90° C.

Discussion

All examples show good initial adhesion after 30 minutes of storage at room temperature, “good” in practical tests being classified as about ≧0.8 N/cm. Even the bond strength after 3 days of storage at 90° C. is only slightly higher than the initial adhesion. However, the level of bond strength can easily be adjusted to the particular requirements as shown in the first two examples.

The fact that the bond strengths on different paints are different opens up the possibility of setting a suitable tailored bond strength profile for different adhesion substrates in each case.

In contrast to the first specimens, the last two are graded as unsatisfactory in performance testing since the changes to the paint are too great

1. A self-adhesive protection film for surface protection applications for painted surfaces, having a single-ply or multi-ply backing layer, and a self-adhesive layer, wherein
the self-adhesive composition is constructed as follows:

| | |
|---|---|
| 30% to 70% by weight | of one or more elastomers based on block |
| | copolymers, including polymer blocks formed |
| | from vinylaromatics (A blocks) and blocks |
| | formed by polymerizing 1,3-dienes (B blocks), |
| | and also |
| 30 to 70% by weight | of tackifier resins, at least half of the |
| | tackifier resins being liquid tackifier resins having |
| | a softening point of below 25° C. as measured |
| | using the ring and ball method. |

2. The self-adhesive protection film of claim 1, wherein the elastomers are hydrogenated predominantly in the middle block,

3. The self-adhesive protection film of claim 1, wherein the fraction of liquid resins as a proportion of the total resin fraction is above 90 wt. %.

4. The self-adhesive protection film of claim 1, wherein the liquid tackifier resins are hydrogenated hydrocarbon resins.

5. The self-adhesive protection film of claim 1, wherein said self-adhesive composition comprises no plasticizing oil is used.

6. The self-adhesive protection film of claim 1, optionally including an adhesion promoter layer disposed between the backing layer and the adhesive layer, and wherein the thickness of the backing layer is between 20 and 80 μm, including adhesion promoter layer, if present.

7. The self-adhesive protection film of claim 1, wherein the backing layer includes at least one light stabilizer in an amount of at least 0.15% by weight.

8. The self-adhesive protection film of claim 1, wherein the UV transmittance of the protection film in the wavelength range from 290 to 360 nm is below 1%.

9. A process for producing the self-adhesive protection film of claim 1, which comprises simultaneously coextrudinq an adhesive layer, backing layer, and, optionally, further auxiliary layers.

10. A method of protecting painted surfaces of automobiles or automobile parts during assembly or transit, which comprises applying the self-adhesive protection film of claim 1 to said painted surfaces.

11. A method for protecting sensitive paint, metal, plastic or glass surfaces, which comprises applyinq the self-adhesive protection film of claim 1 to said surfaces.

12. The self-adhesive protective film of claim 1, wherein said backing layer is a polyolefinic backing layer.

13. The self-adhesive protective film of claim 1, wherein said vinylaromatics is styrene.

14. The self-adhesive protective film of claim 1, wherein said 1,3-dienes are butadiene and isoprene and/or their hydrogenation products.

15. The self-adhesive protective film of claim 2, wherein said elastomers are hydrogenated completely in the middle block.

16. The self-adhesive protective film of claim 3, wherein said fraction of liquid resins is 100 wt. %.
